(19) United States
(12) Patent Application Publication
(10) Pub. No.: US 2024/0060233 A1
(43) Pub. Date: Feb. 22, 2024

(54) POLYMER DEPOSITION AND ATTACHMENT PROCESS FOR TEXTILES

(71) Applicants: DAIKIN AMERICA, INC., Orangeburg, NY (US); DAIKIN INDUSTRIES, LTD., Osaka-shi, Osaka (JP)

(72) Inventors: James Kasey BRIDGES, Orangeburg, NY (US); Haley EILAND, Orangeburg, NY (US); Masaki FUKUMORI, Orangeburg, NY (US)

(73) Assignees: DAIKIN AMERICA, INC., Orangeburg, NY (US); DAIKIN INDUSTRIES, LTD., Osaka-shi, Osaka (JP)

(21) Appl. No.: 18/267,668

(22) PCT Filed: Jan. 14, 2022
(86) PCT No.: PCT/JP2022/001169

§ 371 Date: Jun. 15, 2023

Related U.S. Application Data
(60) Provisional application No. 63/138,497, filed on Jan. 17, 2021.

(51) Int. Cl. D06M 15/27; D06M 15/267; D06M 15/71

(52) U.S. Cl. CPC D06M 15/27; D06M 15/267; D06M 15/71; D06M 2101/32

(57) ABSTRACT

A system and method for applying a polymer surface treatment to carpets and other textiles is provided. The system and method include the use of a surfactant-free emulsion of a surface treatment polymer. The use of the surfactant-free emulsion of a surface treatment polymer reduces or eliminates the need to use pH adjusting agents and/or ionic salt solutions when applying surface treatment polymers to carpets or other textiles. By reducing the need to remove surfactants, emulsifiers, pH adjusting agents, and/or salts, the total volume of water used in treating carpets or other textiles is reduced.

### CROSS-REFERENCE TO RELATED APPLICATIONS

This Application claims benefit under 35 U.S.C. §119(e) of U.S. Provisional Application No. 63/138,497 filed Jan. 17, 2021, incorporated herein by reference in its entirety.

### TECHNICAL FIELD

This disclosure relates to applying polymer surface treatments to carpets and other textiles, and more specifically to utilizing a surfactant-free emulsion polymer product to improve the soil resistance and/or liquid repellency of textiles.

### BACKGROUND ART

In the carpet and textiles industry, soil resistance and liquid repellency are highly desirable characteristics of carpet and other textiles. As the industry moves away from the use of fluorochemicals, providing improved performance properties at low cost is a challenge.

Typical methods for the surface treatment of carpets and other textiles involve the application of surfactant-stabilized polymer emulsion products to the carpet or other textiles during manufacturing. The surfactant-stabilized emulsion particles are kept suspended in the continuous phase by various surfactants whereas the disclosed polymer surface treatment is stabilized by an ionic moiety inherent to the polymer that keeps it suspended in the continuous phase.

Most of the repellent chemistries for carpet applications are surfactant-stabilized emulsions. Surfactant-based emulsion chemistries require surfactants and emulsifiers to keep the emulsion stable. Acidic pH and salt solutions are used to destabilize the surfactant-stabilized emulsion and release the polymer on to the carpet fibers.

Traditional surfactant-stabilized emulsion surface treatments that are applied via the standard exhaust method typically require a low pH (˜pH 2-3) and the use of a salt solution such as magnesium sulfate. A rinse step may also be needed to remove any remaining surfactants, emulsifiers, salts, and/or acid before drying. These additional process requirements may create problems from an environmental and safety standpoint. Some embodiments of the disclosed surface treatment can be applied via the exhaust method without requiring the use of pH adjustment, salt solutions, or a rinse step. In some embodiments, the disclosed invention achieves better repellency performance than other non-fluorochemical options.

### SUMMARY OF INVENTION

This disclosure relates generally to the application of a surfactant-free emulsion of a polymer surface treatment to carpet and other textiles.

Some disclosed embodiments relate to a method of treating carpet comprising: applying a surfactant-free emulsion of a surface treatment polymer to a carpet wherein the surface treatment polymer is formed by solution polymerization, and drying the carpet after the surfactant-free emulsion of a surface treatment polymer is applied to the carpet. In some embodiments, the surface treatment polymer comprises (a) a repeating unit formed from an acrylic monomer having a hydrocarbon group containing 7 to 40 carbon atoms, (b) a repeating unit formed from an acrylic monomer having a hydrophilic group, and (c) a repeating unit formed from a monomer having an ion-donating group. In some embodiments, the step of drying the carpet is performed without rinsing the carpet after the surfactant-free emulsion is applied to the carpet.

Some disclosed embodiments relate to methods and process steps for treating carpet that may be used in-line as part of a continuous or semi-continuous manufacturing process.

The above presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

Preferable embodiments of this disclosure are as follows:

Embodiment 1. A method of treating carpet comprising:
applying a surfactant-free emulsion of a surface treatment polymer to a carpet wherein the surface treatment polymer is formed by solution polymerization, and
drying the carpet after the surfactant-free emulsion of a surface treatment polymer is applied to the carpet.

Embodiment 2. The method of treating carpet of Embodiment 1, wherein the step of drying the carpet is performed by heating the carpet.

Embodiment 3. The method of treating carpet of Embodiment 2, wherein the carpet is heated to a temperature of at least 60° C. or above 93° C. (200° F.) for a time of 1 seconds to 500 minutes.

Embodiment 4. The method of treating carpet of Embodiment 1, wherein the step of drying the carpet is performed without rinsing the carpet after the surfactant-free emulsion is applied to the carpet.

Embodiment 5. The method of treating carpet of Embodiment 1, wherein the surfactant-free emulsion is applied to the carpet without the use of a salt solution.

Embodiment 6. The method of treating carpet of Embodiment 1, wherein the surfactant-free emulsion is applied to the carpet without the use of a magnesium salt solution.

Embodiment 7. The method of treating carpet of Embodiment 1, wherein the carpet is dried before any solution with conductivity of greater than 0.1 mS/cm is applied to the carpet.

Embodiment 8. The method of treating carpet of Embodiment 1, wherein the surfactant-free emulsion is applied to the carpet without the use of a separate acidic solution.

Embodiment 9. The method of treating carpet of Embodiment 1, wherein the surfactant-free emulsion has a pH greater than 4.0 as it is applied to the carpet.

Embodiment 10. The method of treating carpet of Embodiment 1, wherein the surfactant-free emulsion has a pH between 4.5 and 10.0 as it is applied to the carpet.

Embodiment 11. The method of treating carpet of Embodiment 1, wherein the carpet is dried before any separate pH adjusting agent is applied to the carpet.

Embodiment 12. The method of treating carpet of Embodiment 1, wherein the surfactant-free emulsion is substantially free of emulsifiers.

Embodiment 13. The method of treating carpet of Embodiment 1, wherein the surface treatment polymer is fluorine free.

Embodiment 14. The method of treating carpet of Embodiment 1, wherein the surface treatment polymer comprises (a) a repeating unit formed from an acrylic monomer having a hydrocarbon group containing 7 to 40 carbon atoms, (b) a repeating unit formed from an acrylic monomer having a hydrophilic group, and (c) a repeating unit formed from a monomer having an ion-donating group.

Embodiment 15. The method of treating carpet of Embodiment 14, wherein the ion-donating group is a cation-donating group.

Embodiment 16. The method of treating carpet of Embodiment 15, wherein the cation-donating group is an amino group.

Embodiment 17. A method (or system) of treating a textile comprising:
saturating the textile with a treatment bath, the treatment bath comprising a surfactant-free emulsion of a surface treatment polymer, wherein the surface treatment polymer comprises (a) a repeating unit formed from an acrylic monomer having a hydrocarbon group, (b) a repeating unit formed from an acrylic monomer having a hydrophilic group, and (c) a repeating unit formed from a monomer having a cation-donating group; and

heating the textile to reduce the moisture content without rinsing the textile after saturating the textile with the treatment bath.

Embodiment 18. The method of treating a textile of Embodiment 17, wherein the treatment bath is substantially free of emulsifiers.

Embodiment 19. The method of treating a textile of Embodiment 17, wherein the textile is a continuous or semi-continuous web of carpet.

Embodiment 20. The method of treating a textile of Embodiment 17, wherein the textile is a carpet comprising polyethylene terephthalate (PET) or polytrimethylene terephthalate (PTT) fibers.

### BRIEF DESCRIPTION OF DRAWINGS

FIG. 1 illustrates an outline of the solution grades used in the Modified AATCC liquid repellency test method 193-2017 discussed herein.

### DESCRIPTION OF EMBODIMENTS

The embodiments set forth below represent the necessary information to enable those skilled in the art to practice the disclosure and illustrate the best mode of practicing the disclosure. Upon reading the following description in light of the accompanying drawings, those skilled in the art will understand the concepts of the disclosure and will recognize applications of these concepts not particularly addressed herein. It should be understood that these concepts and applications fall within the scope of the disclosure and the accompanying claims.

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Typical, exemplary degrees of error or variation are within 20%, preferably within 10%, and more preferably within 5% of a given value or range of values. Numerical quantities given in this description are approximate unless stated otherwise, meaning that the term “about” or “approximately” can be inferred when not expressly stated. Numerical quantities in the claims are exact unless stated otherwise.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting. As used herein, the singular forms “a”, “an” and “the” are intended to include the plural forms as well, unless the context clearly indicates otherwise.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “at least one of A and B” should be understood to mean “only A, only B, or both A and B.” The same construction should be applied to longer lists (e.g., “at least one of A, B, and C”).

As used herein, chemical formulations including parentheses may include, or not include, the term contained in parentheses. For example, the term “(meth)acrylic” means acrylic or methacrylic. As a second example, “(meth) acrylate” means acrylate or methacrylate.

The term “consisting essentially of” means that, in addition to the recited elements, what is claimed may also contain other elements (steps, structures, ingredients, components, etc.) that do not adversely affect the operability of what is claimed for its intended purpose as stated in this disclosure. This term excludes such other elements that adversely affect the operability of what is claimed for its intended purpose as stated in this disclosure, even if such other elements might enhance the operability of what is claimed for some other purpose.

In some places reference is made to standard methods, such as but not limited to methods of measurement. It is to be understood that such standards are revised from time to time, and unless explicitly stated otherwise reference to such standard in this disclosure must be interpreted to refer to the most recent published standard as of the time of filing.

This disclosure describes embodiments of a method and system for treating carpet and other textiles to improve liquid repellency. While the disclosed embodiments are described in the context of carpet surface treatments, it will be appreciated that the disclosed embodiments could be applied to other textiles, including natural and/or synthetic fiber textiles.

Traditional carpet surface treatment polymers are formed using emulsion polymerization. Emulsion polymerization typically involves an aqueous continuous phase, one or more emulsifiers, a water-soluble initiator, monomers, and/or a chain transfer agent. During emulsion polymerization, monomers diffuse through the aqueous continuous phase until coming into contact with an emulsifier or a group of emulsifiers in the form of a micelle. The hydrophobic monomers are contained within the emulsion until an initiator causes the monomers to polymerize. The product of emulsion polymerization is generally an emulsion of surfactant-stabilized polymer particles in an aqueous continuous phase.

Embodiments of the disclosed surface treatment polymer are made using a solution polymerization method. Solution polymerization involves combining one or more types of monomers in a solvent with an initiator. The monomers react with each other in solution to form a polymer product that can remain in solvent or be solidified by precipitation or the removal of the solvent. The polymer product can also go through a solvent exchange process in which the continuous phase solvent transitions from an organic phase to an aqueous phase.

The product of the disclosed solution polymerization is a colloidal solution, which converts into a surfactant-free emulsion upon cooling. In some embodiments, the disclosed product converts from a colloidal solution to a surfactant-free emulsion around about 45° C. Unlike the emulsion polymerization products, which are stabilized in the aqueous continuous phase by surfactants and/or emulsifiers, once the disclosed surfactant-free emulsion is converted from solvent to an aqueous based continuous phase, it is stabilized in that aqueous continuous phase by an ionic moiety inherent to the polymer.

In some embodiments, the disclosed surface treatment polymer is free or substantially free of fluorine.

In some embodiments, the disclosed surfactant-free emulsion is free or substantially free of emulsifiers. The amount of the emulsifiers is preferably 0 to 0.01 parts by weight, more preferably 0 to 0.001 (or 0 to 0.0001) parts by weight, particularly 0 part by weight, based on 1 part by weight of the surface treatment polymer,

### (1) Surface Treatment Polymer

Embodiments of disclosed surface treatment polymer (1) comprises (a) a repeating unit formed from an acrylic monomer having a hydrocarbon group containing 7 to 40 carbon atoms, (b) a repeating unit formed from an acrylic monomer having a hydrophilic group, and (c) a repeating unit formed from a monomer having an ion-donating group, in addition to the monomers (a) and (b).

In some embodiments, the surface treatment polymer may also comprise (d) a repeating unit formed from another monomer, in addition to the monomers of (a), (b), and (c).

### (a) Acrylic Monomer having a Long-Chain Hydrocarbon Group

The long-chain hydrocarbon group-containing monomer has a hydrocarbon group having 7 to 40 carbon atoms. The long-chain hydrocarbon group is preferably a linear or branched hydrocarbon group having 7 to 40 carbon atoms. The number of carbon atoms in the linear or branched hydrocarbon group may be 10 to 40, 12 to 30 or 14 to 22. The linear or branched hydrocarbon group has preferably 12 to 40, more preferably 12 to 30, particularly preferably 14 to 22, especially preferably 16 to 20 (or 16 to 22) carbon atoms, and is preferably a saturated aliphatic hydrocarbon group, particularly an alkyl group. The long-chain hydrocarbon group is particularly preferably a stearyl group, an icosyl group or a behenyl group.

The long-chain hydrocarbon group-containing monomer is preferably a monomer of the formula:

CH₂═C(−X¹)-C(═O)-Y¹(R¹)ₖ

wherein R¹ each is independently a hydrocarbon group having 7 to 40 carbon atoms,

X¹ is a hydrogen atom, a monovalent organic group or a halogen atom excluding a fluorine atom,

Y¹ is a group consisting of at least one moiety selected from a divalent to tetravalent hydrocarbon group having 1 carbon atom, —C₆H₄—, —O—, —C(═O)-, -S(═O)₂- and —NH—, and

k is an integer of 1 to 3.

X¹ may be a hydrogen atom, a methyl group, a halogen except for a fluorine atom, a cyano group, a substituted or unsubstituted benzyl group, or a substituted or unsubstituted phenyl group. Examples of X¹ include a hydrogen atom, a methyl group, a chlorine atom, a bromine atom, an iodine atom and a cyano group. X¹ is preferably a hydrogen atom, a methyl group or a chlorine atom. X¹ is particularly preferably a hydrogen atom, because of higher water repellency and higher soil resistance.

Y¹ is a divalent to tetravalent group. Y¹ is preferably a divalent group. Y¹ is preferably a group containing at least one moiety selected from a hydrocarbon group having 1 carbon atom, —C₆H₄—, —O—, —C(═O)-, —S(═O)₂ and —NH—. Examples of the hydrocarbon group having 1 carbon atom include —CH₂—, —CH═ and —C≡

Examples of Y¹ include —Y′—, —Y′—C(═O)-, —C(═O)-Y′—, —Y′—C(═O)-Y′—, —Y′—C(═O)-Y′—, —Y′—R′—, —Y′—R′—Y′—, —Y′—R′—Y′—C(═O)-, —Y′—R′—C(═O)-Y′—, —Y′—R′—Y′—C(═O)Y′— and Y′—R′—Y′—R′—

wherein Y′ is a direct bond, —O— or —NH—,

R′ is -(CH₂)ₘ- (wherein m is an integer of 1 to 5) or —C₆H₄— (phenylene group).

Specific examples of Y¹ include —O—, —NH—, —O—C(═O)-, —C(═O)-NH—, —NH—C(═O)-, —O—C(═O)-NH—, —NH—C(═O)-O—, —NH—C(═O)-NH—, —O—C₆H₄—, —O-(CH₂)ₘ—O—, —NH-(CH₂)ₘ-NH—,—O-(CH₂)ₘ-NH—, —NH-(CH₂)ₘ—O—,—O-(CH₂)ₘ-O—C(═O)-, —O-(CH₂)ₘ-C(═O)-O—, —NH-(CH₂)ₘ-O—C(═O)-, —NH-(CH₂)ₘ-C(═O)-O—, —O-(CH₂)ₘ-O—C(═O)-NH—, —O-(CH₂)ₘ-NH—C(═O)-O—, —O-(CH₂)ₘ-C(═O)-NH—, —O-(CH₂)ₘ-NH—C(═O)-, —O-(CH₂)ₘ-NH—C(═O)-NH—, —O-(CH₂)ₘ-S(═O)₂-NH—, —O-(CH₂)ₘ-N H—S(═O)₂-, —O-(CH₂)ₘ-O—C₆H₄—, —NH-(CH₂)ₘ-O—C(═O)-NH—, —NH-(CH₂)ₘ-NH—C(═O)-O—, —NH-(CH₂)ₘ-C(═O)-NH—, —NH-(CH₂)ₘ-NH—C(═O)-, —NH-(CH₂)ₘ-NH—C(═O)-NH—, —NH-(CH₂)ₘ-O—C₆H₄—, and —NH-(CH₂)ₘ-NH—C₆H₄— wherein m is an integer of 1 to 5, particularly 2 or 4.

Y¹ is more preferably —O—, —NH—, —O-(CH₂)ₘ-O—C(═O)-, —O-(CH₂)ₘ-NH—C(═O)-, —O-(CH₂)ₘ-O—C(═O)-NH—, —O-(CH₂)ₘ-NH—C(═O)-O—, —O-(CH₂)ₘ-NH—C(═O)-NH—, —O-(CH₂)ₘ-NH—S(═O)₂- or —O-(CH₂)ₘ-S(═O)₂-NH—

wherein m is an integer of 1 to 5, particularly 2 or 4.

Y¹ is particularly preferably —O—, —NH—, —O-(CH₂)ₘ-NH—C(═O)-, —O-(CH₂)ₘ-O—C(═O)-NH—, —O-(CH₂)ₘ-NH—C(═O)-O—, —O-(CH₂)ₘ-NH—C(═O)-NH—, especially —O-(CH₂)ₘ-NH—C(═O)-,

wherein m is an integer of 1 to 5, particularly 2 or 4.

R¹ is preferably a linear or branched hydrocarbon group. The hydrocarbon group may be particularly a linear hydrocarbon group. The hydrocarbon group is preferably an aliphatic hydrocarbon group, particularly a saturated aliphatic hydrocarbon group, especially an alkyl group. The number of carbon atoms in the hydrocarbon group is preferably 12 to 30, for example 15 to 26, particularly 17 to 22.

k is an integer of 1 to 3, preferably 1.

Examples of the long-chain hydrocarbon group-containing monomer include:

(a1) an acrylic monomer represented by the formula:

CH₂═C(-X⁴)-C(═O)-Y²-R²

wherein R² is a hydrocarbon group having 7 to 40 carbon atoms,

X⁴ is a hydrogen atom, a monovalent organic group or a halogen atom excluding a fluorine atom, and

Y² is —O— or —NH—.

(a2) an acrylic monomer represented by the formula:

CH₂═C(-X⁵)-C(═O)-Y³-Z(-Y⁴-R³)ₙ

wherein R³ each is independently a hydrocarbon group having 7 to 40 carbon atoms,

X⁵ is a hydrogen atom, a monovalent organic group or a halogen atom excluding a fluorine atom,

Y³ is —O— or —NH—,

Y⁴ each is independently a direct bond, or a group consisting of at least one moiety selected from, —O—, —C(═O)-, —S(═O)₂- and —NH—, and

Z is a direct bond, or a divalent or trivalent group having 1 to 5 carbon atoms, and

n is 1 or 2.

### (a1) Acrylic Monomer

The acrylic monomer (al) is a compound of the formula:

CH₂═C(-X⁴)-C(═O)-Y²-R²

wherein R² is a hydrocarbon group having 7 to 40 carbon atoms,

X⁴ is a hydrogen atom, a monovalent organic group or a halogen atom excluding a fluorine atom, and

Y² is —O— or —NH—.

The acrylic monomer (a1) is a long-chain acrylate ester monomer in which Y² is —O—; or a long-chain acrylamide monomer in which Y² is —NH—.

R² is preferably a linear or branched hydrocarbon group. The hydrocarbon group may be particularly a linear hydrocarbon group. The hydrocarbon group is preferably an aliphatic hydrocarbon group, particularly a saturated aliphatic hydrocarbon group, especially an alkyl group. The number of carbon atoms in the hydrocarbon group is preferably 12 to 30, for example 16 to 26, particularly 18 to 22.

X⁴ may be a hydrogen atom, a methyl group, a halogen except for a fluorine atom, a cyano group, a substituted or unsubstituted benzyl group or a substituted or unsubstituted phenyl group. Examples of X⁴ include a hydrogen atom, a methyl group, a chlorine atom, a bromine atom, an iodine atom and a cyano group. X⁴ is preferably a hydrogen atom, a methyl group or a chlorine atom.

Specific examples of the long-chain acrylate ester monomer include lauryl (meth)acrylate, stearyl (meth)acrylate, icosyl (meth)acrylate, behenyl (meth)acrylate, stearyl a-chloroacrylate, icosyl a-chloroacrylate and behenyl a-chloroacrylate.

Specific examples of the long-chain acrylamide monomer include lauryl (meth)acrylamide, stearyl (meth)acrylamide, icosyl (meth)acrylamide and behenyl (meth)acrylamide.

In some embodiments, the long-chain acrylate ester monomer and/or the long-chain acrylamide monomer enhance water-repellency which is imparted by the surface treatment polymer.

### (a2) Acrylic Monomer

The acrylic monomer (a2) is a compound different from the acrylic monomer (a1). The acrylic monomer (a2) is a (meth)acrylate or a (meth)acrylamide having a group consisting of at least one moiety selected from —O—, —C(═O)-, —S(═O)₂-, or —NH—.

The acrylic monomer (a2) is a compound of the formula:

CH₂═C(-X⁵)-C(═O)-Y³-Z(—Y⁴—R³)ₙ

wherein R³ each is independently a hydrocarbon group having 7 to 40 carbon atoms,

X⁵ is a hydrogen atom, a monovalent organic group or a halogen atom excluding a fluorine atom,

Y³ is —O— or —NH—,

Y⁴ each is independently a direct bond, or a group consisting of at least one moiety selected from, —O—, -C(═O)-, -S(═O)₂- and —NH—, and

Z is a direct bond, or a divalent or trivalent group having 1 to 5 carbon atoms, and n is 1 or 2.

The acrylic monomer (a2) is a long-chain acrylate ester monomer in which Y³ is —O—; or a long-chain acrylamide monomer in which Y³ is —NH—.

R³ is preferably a linear or branched hydrocarbon group. The hydrocarbon group may be particularly a linear hydrocarbon group. The hydrocarbon group is preferably an aliphatic hydrocarbon group, particularly a saturated aliphatic hydrocarbon group, especially an alkyl group. The number of carbon atoms in the hydrocarbon group is preferably 12 to 30, for example, 15 to 26, or 16 to 26, particularly 17 to 22 (or 18 to 24).

X⁵ may be a hydrogen atom, a methyl group, a halogen except for a fluorine atom, a cyano group, a substituted or unsubstituted benzyl group or a substituted or unsubstituted phenyl group. Examples of X⁵ include a hydrogen atom, a methyl group, a chlorine atom, a bromine atom, an iodine atom and a cyano group. X⁵ is preferably a hydrogen atom, a methyl group or a chlorine atom, more preferably a hydrogen atom or a methyl group, particularly preferably a hydrogen atom, because of higher water repellency and higher antifouling property.

Examples of Y⁴ include —Y′—, —Y′—Y′—, —Y′—C(═O)-, —C(═O)-Y′—, —Y′—C(═O)-Y′—, —Y′—R′—, —Y′—R′—Y′—, —Y′—R′—Y′—C(═O)-, —Y′—R′—C(═O)-Y′—, —Y′—R′—Y′—C(═O)-Y′—, or —Y′—R′—Y′—R′—

wherein each Y′ is independently a direct bond, —O—, —NH— or —S(═O)₂-, and each R′ is independently -(CH₂)ₘ-, where m is an integer of 1 to 5, a linear hydrocarbon group of 1 to 5 carbon atoms having an unsaturated bond, a hydrocarbon group of 1 to 5 carbon atoms having a branched structure, or -(CH₂)_{I}-C₆H₄-(CH₂)_{I}-, where each I is independently an integer of 0 to 5, and —C₆H₄- is a phenylene group.

Specific examples of Y⁴ include a direct bond, —O—, —NH—, —O—C(═O)-, —C(═O)-O—, —C(═O)-NH—, —NH—C(═O)-, —S(═O)₂-NH—, —NH—S(═O)₂-, —O—C(═O)-NH—, —NH—C(═O)-O—, —NH—C(═O)-NH—, —O—C₆H₄—, —NH—C₆H₄—, —O-(CH₂)ₘ-O—, —NH-(CH₂)ₘ-NH—, —O-(CH₂)ₘ-NH—, —NH-(CH₂)ₘ-O—, —O-(CH₂)ₘ-O—C(═O)-, —O-(CH₂)ₘ-C(═O)-O—, —NH-(CH₂)ₘ-O—C(═O)-, —NH-(CH₂)ₘ-C(═O)-O—, —O-(CH₂)ₘ-O—C(═O)-NH—, —O-(CH₂)ₘNH—C(═O)-O—, —O-(CH₂)ₘ-C(═O)-NH—, —O-(CH₂)ₘ-NH—C(═O)-, —O-(CH₂)ₘ-NH—C(═O)-NH—, —O-(CH₂)ₘ-O—C₆H₄—, —NH-(CH₂)ₘ-O—C(═O)-NH—, —NH-(CH₂)ₘ-NH—C(═O)-O—, —NH-(CH₂)ₘ-C(═O)-NH—, —NH-(CH₂)ₘ-NH—C(═O)-, —NH-(CH₂)ₘ-NH—C(═O)-NH—, —NH-(CH₂)ₘ-O—C₆H₄—, and —NH-(CH₂)ₘ-NH—C₆H₄—

wherein m is an integer of 1 to 5, particularly 2 or 4.

Y⁴ is more preferably —O—, —NH—, —O—C(═O)-, —C(═O)-O—, —C(═O)-NH—, —NH—C(═O)-, —NH—S(═O)₂-, —S(═O)₂-NH—, —O—C(═O)-NH—, —NH—C(═O)-O—, —NH—C(═O)-NH—, or —O—C₆H₄—

wherein m is an integer of 1 to 5, particularly 2 or 4.

Particularly preferably, Y⁴ is —NH—C(═O)-, —C(═O)-NH—, —O—C(═O)-NH—, —NH— C(═O)-O— or —NH—C(═O)-NH—.

Z is a direct bond or a divalent or trivalent hydrocarbon group containing 1 to 5 carbon atoms, which may have a linear structure or a branched structure. Preferably, Z has 2 to 4 carbon atoms, particularly 2 carbon atoms. Specific examples of Z include a direct bond, —CH₂—, —CH₂CH₂—, —CH₂CH₂CH₂—, —CH₂CH₂CH₂CH₂—, —CH₂CH₂CH₂CH₂CH₂—, —CH₂CH═ having a branched structure, —CH₂(CH—)CH₂— having a branched structure, —CH₂CH₂CH═ having a branched structure, CH₂CH₂CH₂CH₂CH═ having a branched structure, —CH₂CH₂(CH—)CH₂— having a branched structure, and —CH₂CH₂CH₂CH═ having a branched structure. Z is preferably not a direct bond, and Y⁴ and Z are not a direct bond at the same time.

The acrylic monomer (a2) is preferably CH₂═C(-X⁵)-C(═O)-O-(CH₂)ₘ-NH—C(═O)-R³, CH₂═C(-X⁵)-C(═O)-O-(CH₂)ₘ-O—C(═O)-NH—R³, CH₂═C(-X⁵)-C(═O)-O-(CH₂)ₘ-NH—C(═O)-O—R³, or CH₂═C(-X⁵)-C(═O)-O-(CH₂)ₘ-NH—C(═O)-NH—R³,

wherein R³, X⁵ and m are as defined above. The acrylic monomer (a2) is particularly preferably CH₂═C(-X⁵)-C(═O)-O-(CH₂)ₘ-NH—C(═O)-R³ wherein R³, X⁵ and m are as defined above.

The acrylic monomer (a2) can be produced by reacting a hydroxyalkyl (meth)acrylate or a hydroxyalkyl (meth)acrylamide with a long-chain alkyl isocyanate. Examples of the long-chain alkyl isocyanate include lauryl isocyanate, myristyl isocyanate, cetyl isocyanate, stearyl isocyanate, oleyl isocyanate and behenyl isocyanate.

Alternatively, the acrylic monomer (a2) can be produced by reacting a long-chain alkylamine or a long-chain alkyl alcohol with a (meth)acrylate having an isocyanate group on side chain, for example 2-methacryloyloxyethyl isocyanate. Examples of the long-chain alkylamine include laurylamine, myristylamine, cetylamine, stearylamine, oleylamine and behenylamine. Examples of the long-chain alkyl alcohol include lauryl alcohol, myristyl alcohol, cetyl alcohol, stearyl alcohol, oleyl alcohol and behenyl alcohol.

Specific examples of the acrylic monomer (a2) are as follows.

stearyl (meth) acrylate, behenyl (meth) acrylate, stearyl a-chloroacrylate, behenyl a-chloroacrylate; stearyl (meth) acrylamide, behenyl (meth) acrylamide;

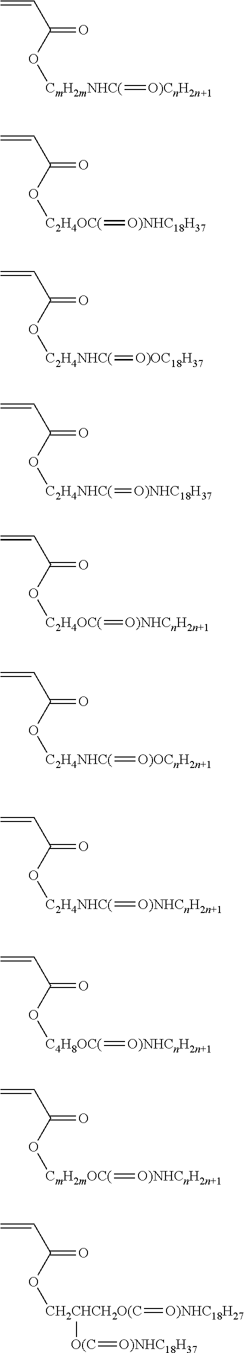

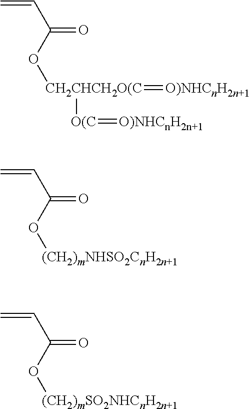

wherein m is an integer of 1 to 5, n is an integer of 7 to 40.

he compounds having the above chemical formulas are an acrylic compound in which the a-position is a hydrogen atom, and specific examples may be a methacrylic compound in which the a-position is a methyl group and an a-chloroacrylic compound in which the a-position is a chlorine atom.

Typical specific examples of the acrylic monomer (a2) include palmitic acid amidoethyl (meth)acrylate, stearic acid amidoethyl (meth)acrylate (i.e., amidoethyl stearate (meth)acrylate), behenic acid amidoethyl (meth)acrylate and myristic acid amidoethyl (meth)acrylate.

The melting point of the long-chain hydrocarbon group-containing acrylic monomer (a) is preferably at least 10° C., more preferably at least 25° C. or at least 40° C.

The long-chain hydrocarbon group-containing acrylic monomer (a) is preferably an acrylate in which each of X¹, X⁴ and X⁵ is a hydrogen atom.

The acrylic monomer (a2) is particularly preferably an amide group-containing monomer of the formula:

R¹²—C(═O)-NH—R¹³—O—R¹¹

wherein R¹¹ is an organic residue having an ethylenically unsaturated polymerizable group,

R¹² is a hydrocarbon group having 7 to 40 carbon atoms, and

R¹³ is a hydrocarbon group having 1 to 5 carbon atoms.

R¹¹ is an organic residue having an ethylenically unsaturated polymerizable group, and is not limited as long as the group has a carbon-carbon double bond. Specific examples thereof include organic residues having ethylenically unsaturated polymerizable groups such as —C(═O)CR¹⁴═CH₂, —CHR¹⁴═CH₂ and —CH₂CHR¹⁴═CH₂, where R¹⁴ is a hydrogen atom or an alkyl group having 1 to 4 carbon atoms. R¹¹ may have any of various organic groups in addition to an ethylenically unsaturated polymerizable group, and examples thereof include organic groups such as chain hydrocarbons, cyclic hydrocarbons, polyoxyalkylene groups and polysiloxane groups. For example, these organic groups may be substituted with various substituents. R¹¹ is preferably —C(═O)CR¹⁴═CH₂.

R¹² is a hydrocarbon group having 7 to 40 carbon atoms, preferably an alkyl group having 7 to 40 carbon atoms, and examples thereof include chain hydrocarbons and cyclic hydrocarbons. Among them, chain hydrocarbons are preferable, and linear saturated hydrocarbon groups are particularly preferable. The number of carbon atoms of R¹² is 7 to 40, preferably 11 to 27, particularly 15 to 23.

R¹³ is a hydrocarbon group having 1 to 5 carbon atoms, preferably an alkyl group having 1 to 5 carbon atoms. For example, the hydrocarbon group having 1 to 5 carbon atoms may be linear or branched, and may have an unsaturated bond. The hydrocarbon group is preferably linear. The number of carbon atoms of R¹³ is preferably 2 to 4, particularly 2. R¹³ is preferably an alkylene group.

The amide group-containing monomer may be one having a single group as R¹¹ (e.g. only a compound in which R¹¹ has 17 carbon atoms), or one having a combination of a plurality of groups as R¹¹ (e.g. a mixture of a compound in which R¹¹ has 17 carbon atoms and a compound in which R¹² has 15 carbon atoms).

Examples of the amide group-containing monomer include carboxylic acid amidealkyl (meth)acrylates. Specific examples of the amide group-containing monomer include palmitic acid amidoethyl (meth)acrylate, stearic acid amidoethyl (meth)acrylate, behenic acid amidoethyl (meth)acrylate, myristic acid amidoethyl (meth)acrylate, lauric acid amidoethyl (meth)acrylate, isostearic acid ethylamide (meth)acrylate, oleic acid ethylamide (meth)acrylate, tertiary butylcyclohexyl caproic acid amidoethyl (meth)acrylate, adamantanecarboxylic acid ethylamide (meth)acrylate, naphthalenecarboxylic acid amidoethyl (meth)acrylate, anthracenecarboxylic acid amidoethyl (meth)acrylate, palmitic acid amidopropyl (meth)acrylate, stearic acid amidopropyl (meth)acrylate, palmitic acid amidoethyl vinyl ether, stearic acid amidoethyl vinyl ether, palmitic acid amidoethyl allyl ether, stearic acid amidoethyl allyl ether and mixtures thereof.

The amide group-containing monomer is preferably stearic acid amidoethyl (meth)acrylate. The amide group-containing monomer may be a mixture containing stearic acid amidoethyl (meth)acrylate. In the mixture containing stearic acid amidoethyl (meth)acrylate, the amount of the stearic acid amidoethyl (meth)acrylate may be, for example, 55 to 99 wt %, preferably 60 to 85 wt %, more preferably 65 to 80 wt %, based on the weight of all amide group-containing monomers, and the other monomers may be, for example, palmitic acid amidoethyl (meth)acrylate.

### (b) Acrylic Monomer having a Hydrophilic Group

The hydrophilic group-containing acrylic monomer (b) is a monomer excluding the monomer (a), and is a hydrophilic monomer. The hydrophilic group is preferably an oxyalkylene group (The carbon number of alkylene group is 2 to 6). In particular, the hydrophilic group-containing acrylic monomer (b) is preferably a polyalkylene glycol mono(meth)acrylate and/or a polyalkylene glycol di(meth)acrylate. The polyalkylene glycol mono(meth)acrylate and the polyalkylene glycol di(meth)acrylate may be compounds respectively represented by general formulas:

CH₂═CX²C(═O)-O-(RO)ₙ-X³ (b1)

and

CH₂═CX²C(═O)-O-(RO)ₙ-C(═O)CX²═CH₂ (b2)

wherein

X² each is independently a hydrogen atom or a methyl group,

X³ is a hydrogen atom or an unsaturated or saturated hydrocarbon group having 1 to 22 carbon atoms,

R each is independently an alkylene group having 2 to 6 carbon atoms, and n is an integer of 1 to 90. n may be, for example, 1 to 50, especially 1 to 30, specifically 1 to 15 or 2 to 15. Alternatively, n may be, for example, 1.

R may be a linear or branched alkylene group, for example, -(CH₂)x- (wherein x is 2 to 6) or -(CH₂)ₓ₁-(CH(CH₃))ₓ₂- wherein x1 and x2 each is 0 to 6, for example, 2 to 5, the total of x1 and x2 is 1 to 4. An order of -(CH₂)ₓ₁- and -(CH(CH₃))ₓ₂- is not limited to the described formula and may be random. In -(RO)ₙ-, R may be at least two types (for example, 2 to 4 types, particularly 2 types). The -(RO)ₙ-group may be, for example, a combination of -(R1O)ₙ₁- and -(R²O)ₙ₂- wherein R1 and R² are, different from each other, an alkylene group having 2 to 6 carbon atoms, n1 and n2 is independently an integer of at least 1, and the total of n1 and n2 is 2 to 90.

R in formulas (b1) and (b2) is particularly preferably an ethylene group, a propylene group, or a butylene group. R in formulas (b1) and (b2) may be a combination of at least two types of alkylene groups. In that case, at least one of R is preferably an ethylene group, a propylene group, or a butylene group. Examples of the combination of R include an ethylene group/propylene group combination, a propylene group/butylene group combination, and an ethylene group/butylene group combination. The monomer (b) may be a mixture of at least two types. In that case, at least one monomer (b) preferably has an ethylene group, a propylene group, or a butylene group for R in formula (b1) or (b2). When the polyalkylene glycol di(meth)acrylate represented by formula (b2) is used, it is not preferable to use the monomer (b2) alone as the monomer (b), and it is preferable to use a combination the monomer (b2) with monomer (b1). Even in this case, the compound represented by formula (b2) is preferably kept in an amount of less than 30% by weight (for example, 1% to 20% by weight), based on the monomer (b).

Specific examples of the hydrophilic group-containing acrylic monomer (b) include, but are not limited to, the following.
CH₂═CHCOO—CH₂CH₂O—H
CH₂═CHCOO—CH₂CH₂CH₂O—H
CH₂═CHCOO—CH₂CH(CH₃)O—H
CH₂═CHCOO—CH(CH₃)CH₂O—H
CH₂═CHCOO—CH₂CH₂CH₂CH₂O—H
CH₂═CHCOO—CH₂CH₂CH(CH₃)O—H
CH₂═CHCOO—CH₂CH(CH₃)CH₂O—H
CH₂═CHCOO—CH(CH₃)CH₂CH₂O—H
CH₂═CHCOO—CH₂CH(CH₂CH₃)O—H
CH₂═CHCOO—CH₂C(CH₃)₂O—H
CH₂═CHCOO—CH(CH₂CH₃)CH₂O—H
CH₂═CHCOO—C(CH₃)2CH₂O—H
CH₂═CHCOO—CH(CH₃)CH(CH₃)O—H
CH₂═CHCOO—C(CH₃)(CH₂CH₃)O—H
CH₂═CHCOO-(CH₂CH₂O)₂-H
CH₂═CHCOO-(CH₂CH₂O)₄-H
CH₂═CHCOO-(CH₂CH₂O)₅-H
CH₂═CHCOO-(CH₂CH₂O)₆-H
CH₂═CHCOO-(CH₂CH₂O)₂₃-CH₃
CH₂═CHCOO-(CH₂CH₂O)₉₀-CH₃
CH₂═CHCOO-(CH₂CH(CH₃)O)₉-H
CH₂═CHCOO-(CH₂CH(CH₃)O)₉-CH₃
CH₂═CHCOO-(CH₂CH(CH₃)O)₁₂-CH₃
CH₂═CHCOO-(CH₂CH₂O)₅-(CH₂CH(CH₃)O)₂-H
CH₂═CHCOO-(CH₂CH₂O)₅-(CH₂CH(CH₃)O)₃-CH₃
CH₂═CHCOO-(CH₂CH₂O)₈-(CH₂CH(CH₃)O)₅-CH₂CH(C₂H₅)C₄H₉
CH₂═CHCOO-(CH₂CH₂O)₂₃-OOC(CH₃)C═CH₂
CH₂═CHCOO-(CH₂CH₂O)₂₀-(CH₂CH(CH₃)O)₅-CH₂—CH═CH₂
CH₂═CHCOO-(CH₂CH₂O)₉-H
CH₂═C(CH₃)COO—CH₂CH₂O—H
CH₂═C(CH₃)COO—CH₂CH₂CH₂O—H
CH₂═C(CH₃)COO—CH₂CH (CH₃)O—H
CH₂═C(CH₃)COO—CH(CH₃)CH₂O—H
CH₂═C(CH₃)COO—CH₂CH₂CH₂CH₂O—H
CH₂═C(CH₃)COO—CH₂CH₂CH(CH₃)O—H
CH₂═C(CH₃)COO—CH₂CH(CH₃)CH₂O—H
CH₂═C(CH₃)COO—CH(CH₃)CH₂CH₂O—H
CH₂═C(CH₃)COO—CH₂CH (CH₂CH₃)O—H
CH₂═C(CH₃)COO—CH₂C(CH₃)₂O—H
CH₂═C(CH₃)COO—CH(CH₂CH₃)CH₂O—H
CH₂═C(CH₃)₀₀₀-C(CH₃)₂CH₂O—H
CH₂═C(CH₃)COO—CH(CH₃)CH(CH₃)O—H
CH₂═C(CH₃)COO-C(CH₃)(CH₂CH₃)O—H
CH₂═C(CH₃)COO-(CH₂CH₂O)₉-H
CH₂═C(CH₃)COO-(CH₂CH₂O)₅-CH₃
CH₂═C(CH₃)COO-(CH₂CH₂O)₉-CH₃
CH₂═C(CH₃)COO-(CH₂CH₂O)₂₃-CH₃
CH₂═C(CH₃)COO-(CH₂CH₂O)₉₀-CH₃
CH₂═C(CH₃)COO-(CH₂CH(CH₃)O)₉-H
CH₂═CHCOO-(CH₂CH(CH₃)O)₉-H
CH₂═C(CH₃)COO-(CH₂CH(CH₃)O)₉-CH₃
CH₂═C(CH₃)COO-(CH₂CH(CH₃)O)₁₂-CH₃
CH₂═C(CH₃)COO-(CH₂CH₂O)₅-(CH₂CH(CH₃)O)₂-H
CH₂═C(CH₃)COO-(CH₂CH₂O)₅(CH₂CH(CH₃)O)₃-CH₃
CH₂═C(CH₃)COO-(CH₂CH₂O)₈-(CH₂CH(CH₃)O)₅-CH₂CH(C₂H₅)C4H9
CH₂═C(CH₃)COO-(CH₂CH₂O)₂₃-COO(CH₃)C═CH₂
CH₂═C(CH₃)COO-(CH₂CH₂O)₂₉-(CH₂CH(CH₃)O)₅-CH₂—CH═CH₂

The monomer (b) is preferably an acrylate in which X² is a hydrogen atom, and is particularly preferably hydroxyethyl acrylate, hydroxypropyl acrylate, and hydroxybutyl acrylate.

### (c) Monomer having an Ion-Donating Group

The ion-donating group-containing monomer (c) is a monomer other than the monomers (a) and (b). Generally, the monomer (c) is a monomer having an ethylenically unsaturated double bond and an ion-donating group. The ion-donating group is an anion- donating group and/or a cation-donating group.

The anion-donating group-containing monomer includes a monomer having a carboxyl group, a sulfonic acid group or a phosphoric acid group. Specific examples of the anion-donating group-containing monomer are (meth)acrylic acid, crotonic acid, maleic acid, fumaric acid, itaconic acid, citraconic acid, vinyl sulfonic acid, (meth)allyl sulfonic acid, styrene sulfonic acid, phosphate acrylate, vinylbenzene sulfonic acid, acrylamido tert-butyl sulfonic acid, and salts thereof.

Examples of the salt of the anion-donating group include an alkali metal salt, an alkaline earth metal salt, and an ammonium salts such as a methyl ammonium salt, an ethanol ammonium salt and a triethanol ammonium salt.

In the monomer having the cation-donating group, examples of the cation-donating group include an amino group, preferably a tertiary amino group and a quaternary amino group. Preferably, in the tertiary amino group, two groups attached to a nitrogen atom are, the same or different, an aliphatic group having 1 to 5 carbon atoms (particularly an alkyl group), an aromatic group having 6 to 20 carbon atoms (an aryl group), or an aromatic aliphatic group having 7 to 25 carbon atoms (particularly an aralkyl group, for example, a benzyl group (C₆H₅—CH₂—)). Preferably, in the quaternary amino group, three groups bonded to a nitrogen atom are, the same or different, an aliphatic group having 1 to 5 carbon atoms (particularly an alkyl group), an aromatic group having 6 to 20 carbon atoms (an aryl group), or an aromatic aliphatic group having 7 to 25 carbon atoms (particularly an aralkyl group, for example, a benzyl group (C₆H₅—CH₂—)). In the tertiary and quaternary amino groups, one remaining group bonded to the nitrogen atom may have a carbon-carbon double bond. The cation-donating group may be in the form of a salt.

The cation-donating group is a salt with an acid (an organic or inorganic acid). Organic acids such as carboxylic acids having 1 to 20 carbon atoms (particularly monocarboxylic acids such as acetic acid, propionic acid, butyric acid and stearic acid) are preferable. Dimethylaminoethyl (meth)acrylate and diethylaminoethyl (meth)acrylate and salts thereof are preferable.

Specific examples of the monomer having a cation-donating group are as follows.
CH₂═CHCOO—CH₂CH₂—N(CH₃)₂ and salt thereof (such as acetate salt)
CH₂═CHCOO—CH₂CH₂—N(CH₂CH₃)₂ and salt thereof (such as acetate salt)
CH₂═C(CH₃)COO—CH₂CH₂—N(CH₃)₂ and salt thereof (such as acetate salt)
CH₂═C(CH₃)COO—CH₂CH₂—N(CH₂CH₃)₂ and salt thereof (such as acetate salt)
CH₂═CHC(O)N(H)-CH₂CH₂CH₂—N(CH₃)₂ and salt thereof (such as acetate salt)
CH₂═CHCOO—CH₂CH₂—N(—CH₃)(—CH₂C₆H₅) and salt thereof (such as acetate salt)
CH₂═C(CH₃)COO—CH₂CH₂—N(—CH₂CH₃)(—CH₂—C₆H₅) and salt thereof (such as acetate salt)
CH₂═CHCOO—CH₂CH₂—N⁺(CH₃)₃Cl⁻
CH₂═CHCOO—CH₂CH₂—N⁺(—CH₃)₂(—CH₂-C₆H₅)Cl⁻
CH₂═C(CH₃)COO—CH₂CH₂—N⁺(CH₃)₃Cl⁻
CH₂═CHCOO—CH₂CH(OH)CH₂—N⁺(CH₃)₃Cl⁻
CH₂═C(CH₃)COO—CH₂CH(OH)CH₂—N⁺(CH₃)₃Cl⁻
CH₂═C(CH₃)COO—CH₂CH(OH)CH₂—N⁺(—CH₂CH₃)₂(—CH₂—C5Hs)Cl⁻
CH₂═C(CH₃)COO—CH₂CH₂—N⁺(CH₃)₃Br⁻
CH₂═C(CH₃)COO—CH₂CH₂—N⁺(CH₃)₃I⁻
CH₂═C(CH₃)COO—CH₂CH₂—N⁺(CH₃)₃O⁻SO₃CH₃
CH₂═C(CH₃)COO—CH₂CH₂—N⁺(CH₃)(—CH₂—C₆H₅)₂Br⁻

The ion-donating group-containing monomer is preferably methacrylic acid, acrylic acid and dimethylaminoethyl methacrylate, more preferably methacrylic acid and dimethylaminoethyl methacrylate.

### (d) Another Monomer

Another monomer (d) is a monomer other than the monomers (a), (b) and (c). Examples of the other monomer (d) include ethylene, vinyl acetate, vinyl chloride, vinyl halide, styrene, a-methylstyrene, p-methylstyrene, (meth)acrylamide, diacetone (meth)acrylamide, methylolated (meth) acrylamide, N-methylol (meth)acrylamide, alkyl vinyl ether, alkyl halide vinyl ether, alkyl vinyl ketone, butadiene, isoprene, chloroprene, glycidyl (meth)acrylate, aziridinyl (meth)acrylate, benzyl (meth)acrylate, isocyanatoethyl (meth) acrylate, cyclohexyl (meth)acrylate, isobornyl (meth)acrylate, short-chain alkyl (meth)acrylate, maleic anhydride, (meth)acrylate having polydimethylsiloxane group, and N-vinylcarbazole.

In some embodiments, the disclosed surface treatment polymer includes, but is not limited to, a combination of monomers constituting the following,

Monomer (a)+monomer (b)+monomer (c)

Monomer (a)+monomer (b)+monomer (c)+monomer (d).

The amount of the repeating unit formed from the monomer (a) is 30 to 95% by weight, preferably 40 to 88 wt % by weight, more preferably 50 to 85% by weight, based on the surface treatment polymer. Alternatively, the amount of the repeating unit formed from the monomer (a) may be at least 20% by weight, at least 30% by weight, at least 40% by weight, at least 50% by weight, at least 60% by weight, or at least 70% by weight, and may be 97% by weight or less, 95% by weight or less, 90% by weight or less, 85% by weight or less, 80% by weight or less, 70% by weight or less, or 60% by weight or less, based on the total of the monomer (a), the monomer (b), and the monomer (c).

The amount of repeating unit formed from the monomer (b) may be 5 to 70% by weight, preferably 6 to 50% by weight, more preferably 8 to 25% by weight, based on the surface treatment polymer. Alternatively, the amount of repeating unit formed from monomer (b) may be at least 3% by weight, at least 5% by weight, at least 10% by weight, or at least 15% by weight, and may be 70% by weight or less, 60% by weight or less, 50% by weight or less, 40% by weight or less, 30% by weight or less, 25% by weight or less, or 20% by weight or less, based on the total of the monomer (a), the monomer (b), and the monomer (c).

The amount of the repeating unit formed from the monomer (c) may be 0.1 to 30 wt %, preferably 0.5 to 15 wt %, more preferably be 1 to 10% by weight, based on the total of the monomer (a), the monomer (b), and the monomer (c).

A weight ratio of the repeating unit formed from monomer (b) to the repeating unit formed from monomer (c) may be 5:1 to 0.5:1, for example 4:1 to 1:1, especially 3.5:1 to 2.5:1.

The amount of the repeating unit formed from the monomer (d) may be 0 to 20% by weight, for example 1 to 15% by weight, particularly 2 to 10% by weight, based on the surface treatment polymer.

A weight-average molecular weight of the surface treatment polymer may be 1,000 to 10,000,000, preferably 5,000 to 8,000,000, more preferably 10,000 to 4,000,000. The weight-average molecular weight is a value obtained in terms of polystyrene by gel permeation chromatography.

### (2) Aqueous Medium

The aqueous medium may be water alone, or a mixture of water and an (water-soluble) organic solvent (such as an alcohol, an ester and a ketone). The amount of the organic solvent may be at most 30% by weight, for example, at most 10% by weight, based on the aqueous medium. The aqueous medium is preferably water alone. The amount of the aqueous medium may be 0.2 to 100 parts by weight, for example 0.5 to 50 parts by weight, particularly 1 to 20 parts by weight, based on 1 part by weight of the surface treatment polymer.

The polymerization of the surface treatment polymer polymerization may be various polymerization methods such as a mass polymerization, a solution polymerization, or a radiation polymerization. For example, in general, the solution polymerization using an organic solvent. Preferably, after the polymerization, water is added and then the organic solvent is removed to disperse polymer in water. A self-dispersive product can be manufactured without the need of adding an emulsifier.

Further, for the purpose of adjusting the molecular weight, a chain transfer agent such as a mercapto group-containing compound may be used. Specific examples of the chain transfer agent include 2-mercaptoethanol, thiopropionic acid, and alkyl mercaptan. The chain transfer agent such as the mercapto group-containing compound may be used in the amount of 10 parts by weight or less, for example, 0.01 to 5 parts by weight, based on 100 parts by weight of the monomers.

Specifically, some embodiments of the surface treatment polymer can be manufactured as follows. When using solution polymerization, a method is adopted in which monomer is dissolved in an organic solvent, the ambient atmosphere is replaced with nitrogen, a polymerization initiator is added, and the mixture is heated and stirred, for example, at a temperature of 40 to 120° C. for 1 to 10 hours. Generally, the polymerization initiator may be an oil-soluble polymerization initiator.

The organic solvent is inert to the monomers and dissolves the monomers. Examples of the organic solvent include ketones such as acetone and methyl ethyl ketone; esters such as ethyl acetate and methyl acetate; glycols such as propylene glycol, dipropylene glycol monomethyl ether and N-methyl-2-pyrrolidone (NMP), dipropylene glycol, tripropylene glycol, low molecular weight polyethylene glycol; alcohols such as ethyl alcohol and isopropanol; and hydrocarbon solvents such as n-heptane, n-hexane, n-octane, cyclohexane, methylcyclohexane, cyclopentane, methylcyclopentane, methylpentane, 2-ethylpentane, isoparaffinic hydrocarbons, liquid paraffins, decane, undecane, dodecane, mineral spirits, mineral tarpene and naphtha. Preferable examples of the organic solvent include, for example, acetone, chloroform, HCHC225, isopropyl alcohol, pentane, hexane, heptane, octane, cyclohexane, benzene, toluene, xylene, petroleum ether, tetrahydrofuran, 1,4-dioxane, methyl ethyl ketone, methyl isobutyl ketone, ethyl acetate, butyl acetate, 1,1,2,2-tetrachloroethane, 1,1,1-trichloroethane, trichloroethylene, perchlorethylene, tetrachlorodifluoroethane, trichlorotrifluoroethane, N-methyl-2-pyrrolidone (NMP), and dipropylene glycol monomethyl ether (DPM). The organic solvent is used in the amount of 50 to 2000 parts by weight, for example, 50 to 1000 parts by weight, based on 100 parts by weight of the total of the monomers.

Surfactant-stabilized emulsion polymer surface treatments are typically applied to carpets or other textiles in a multi-step process requiring acidic, ionic conditions, and/or heat to destabilize the emulsion and release the polymer onto the material fibers. A metal salt solution is typically used to generate the ionic conditions for destabilizing the surfactant-stabilized emulsion. Acidic pH is also typically used to destabilize the surfactant-stabilized emulsion. Once the surfactant-stabilized emulsion is destabilized, the polymer is deposited onto the carpet or other textile fibers. The physical and chemical conditions used to destabilize the surfactant-stabilized emulsion create a potentially hazardous environment for operators and may have a negative environmental impact.

In some embodiments, an ionic solution and/or salt solution may have a conductivity of greater than about 0.1 mS/cm, greater than about 0.2 mS/cm, greater than about 0.3 mS/cm, or greater than about 0.5 mS/cm. In some embodiments, a solution of greater than 0.1 mS/cm may be applied to the carpet to destabilize a surfactant-stabilized emulsion. In some embodiments, the treatment bath comprising a surfactant-free emulsion of surface treatment polymer will have a conductivity of less than about 0.1 mS/cm, less than about 0.08 mS/cm, less than about 0.06 mS/cm, less than about 0.05 mS/cm, or less than about 0.04 mS/cm.

Once the destabilized surfactant-stabilized emulsion is applied to a carpet, any surfactants, emulsifiers, acidic agents and/or salts remain on the fibers in addition to any polymer surface treatment. Additional rinse steps are then required to remove these surfactants, emulsifiers, acids, and/or salt compounds. The rinsate must then go through a water treatment process in order to mitigate the environmental damage of this process.

Embodiments of the disclosed aqueous surfactant-free emulsion surface treatment method can save both time and energy as it does not require strongly acidic or ionic conditions to apply the polymer surface treatment to carpets, textiles, or other substrates. In some embodiments, the pH of the surfactant-free emulsion (before being diluted into a treatment bath) is between about 3.0 and about 6.0. In some embodiments, the pH of the surfactant-free emulsion is between about 4 and about 5. Once the surface treatment surfactant-free emulsion is diluted into a treatment bath to be applied to a carpet or other textile, the treatment bath may have a pH between about 5.0 and about 7.5 depending on the local water quality. In some embodiments, the treatment bath will have a pH between about 6.0 and about 7.0. In some embodiments, the surfactant-free emulsion has a pH greater than 4.0 as it is applied to the carpet. In some embodiments, the surfactant-free emulsion has a pH between 4.5 and 10.0 as it is applied to the carpet.

As described above, the disclosed surface treatment polymer includes ionic moieties that stabilize the surface treatment polymer within an aqueous continuous phase without the use of surfactants of emulsifiers.

In one embodiment, the surface treatment polymer is applied to carpet during manufacturing while the carpet is in a continuous or semi-continuous web form. The disclosed surfactant-free emulsion polymer surface treatment is applied to the carpet web, thereby allowing the surfactant-free emulsion to saturate the carpet. Following the saturation, the carpet web enters a steam chamber or other heating device where the carpet saturated with surfactant-free emulsion surface treatment is heated, for example, to a temperature of 60° C. to 200° C. or 80° C. to 150° C. for a time of 1 second to 500 minutes, or 2 seconds to 100 minutes, for example, 10 seconds to 50 minutes, or 1 minute to 10 minutes. Because the surface treatment polymer is in a surfactant-free emulsion, rather than a surfactant-stabilized emulsion, the polymer readily affixes to the carpet fibers once exposed to heat. The surface treatment polymer attaches to the carpet fibers both chemically and physically.

Attachment of the surface treatment polymer to the carpet fibers is caused by both van der Waals forces and dipole-dipole interactions between the surface treatment polymer and the polymer carpet fibers. Film formation may also occur on the surface of fiber.

In some embodiments, once the carpet web leaves the steam chamber, the carpet is vacuumed (for example, 0.0001 atm to 0.5 atm) at a temperature of 0° C. to 80° C. or 10° C. to 50° C. (for example, a room temperature, such as 20° C.) to reduce the total moisture to approximately 0%-70% or 30%-50% and then dried for 10 seconds to 24 hours or 10 minutes to 2 hours. In some embodiments, the carpet is heated to above about 100° C. or 212° F. to dry the carpet. In some embodiments, the carpet is heated to above about 93° C. (200° F.) to dry the carpet. A heating temperature of the carpet may be at least 60° C., such as 60° C. to 200° C. or 80° C. to 150° C., for example, 90° C. to 120° C. A heating may be performed for a time of 1 second to 500 minutes, or 2 seconds to 100 minutes, for example, 10 seconds to 50 minutes, or 1 minute to 10 minutes.

As the disclosed surface treatment polymer is maintained in a surfactant-free emulsion without the use of surfactants, emulsifiers, acids, or salts, no rinse step or other post-processing, other than drying, is required after the surface treatment polymer is applied to the carpet.

The amount of the surfactants (or emulsifiers) is preferably 0 to 0.01 parts by weight, more preferably 0 to 0.001 (or 0 to 0.0001) parts by weight, particularly 0 part by weight, based on 1 part by weight of the surface treatment polymer, although the amount of the surfactants (and/or emulsifiers) may be 0 to 0.1 parts by weight, based on 1 part by weight of the surface treatment polymer.

In some embodiments, the step of drying the carpet is performed without rinsing the carpet after the surfactant-free emulsion is applied to the carpet.

After the surfactant-free emulsion surface treatment is applied and the treated carpet is dried, the finished, primary-backed carpet roll may be sent to a coater. The coater is typically a separate line where a secondary backing is attached to the back of the carpet with a latex composition. The latex composition glues the layers together locking in the yarn tufts and forming a more structurally sound substrate.

In some embodiments, rather than saturating carpet or textiles in a treatment bath, the surface treatment polymer may be applied in the form of a spray or a foam. In such embodiments, the carpet or textile may not be completely saturated but it will be appreciated that the surface treatment polymer is brought into contact with the carpet or textile fibers through a similar process.

In some embodiments, a foaming agent is mixed with the aqueous surfactant-free emulsion surface treatment. A surface treatment polymer foam may be generated with a static or dynamic foam generator and applied to a carpet face. The surface treatment polymer foam may then be pressed into the carpet fiber using a press-roll before the carpet is heated and dried.

In some embodiments, a surfactant-free emulsion surface treatment is applied to a carpet using spray nozzles. The use of spray nozzles reduces the total volume of liquid required to apply the surface treatment polymer to the fibers of the carpet or textile.

The majority of modern carpeting is made from polymer fibers including, for example, Polyethylene terephthalate (PET), Nylon 6, Nylon 6,6, Polytrimethylene terephthalate (PTT), and Polypropylene (PP). Carpet face weight is defined as the ounce of fiber per square yard (osy). Face weight is the weight of the fiber only without any latex backing or other components. Carpet face weights range from less than 20 osy to 100 osy but are typically about 20 osy to about 60 osy.

Formulations for carpet surface treatments can include many components. Generally, there are performance chemistries such as the disclosed surface treatment polymer, auxiliaries, and water in a formulation. Performance chemistries can include, but are not limited to, repellents, anti-soiling additives, odor control additives, anti-microbial additives, and stain-blockers. Auxiliaries can include, but are not limited to, acid, salt solution, and foaming agents. Water is generally the continuous phase of surface treatment formulations. The other components of the formulation are distributed throughout the aqueous continuous phrase. As described above, in some embodiments, the disclosed surface treatment polymer is applied to the carpet and then the carpet is dried. Once the carpet is dried, the surface treatment polymer remains attached to the fibers. In typical exhaust applications, the auxiliaries, surfactants, and/or emulsifiers are rinsed out of the carpet fibers before the carpet is dried.

When treating carpets, there is a targeted amount of surface treatment polymer desired to be present on the finished carpet to achieve the desired level of performance. The amount of polymer deposited onto the carpet fibers is described as percent polymer on weight of fiber (“owf % polymer”).

The percent polymer on weight of fiber (owf % polymer) is the amount of surface treatment polymer deposited on the carpet once all liquid is removed from the carpet by the drying process. A numerical value of owf % polymer may be 0.001 to 200 or 0.01 to 100, for example, 0.05 to 20 or 0.1 to 10.

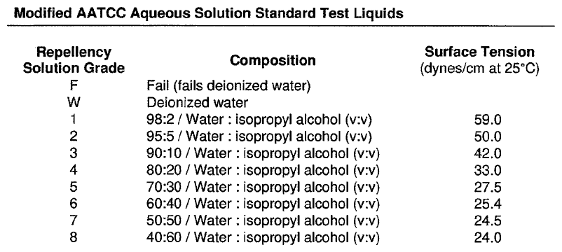

The performance of the surface treatment polymer on various carpet samples can be measured in multiple ways. AATCC test method 193-2017 is used to determine the degree of repellency (non-wetting) of a fabric based on liquids with various surface tensions. A modified version of this test may be used for testing carpet. As shown in FIG. 1, several grades of standardized solution are used to perform the Modified AATCC test method 193-2017. Initially, three drops of Grade W solution (deionized water) are applied to the pile of a carpet sample and observed for 30 seconds. The traditional AATCC test method 193-2017 for testing fabric substrates requires observing the drop for 10±2 seconds. In the modified version of this test for carpet testing, a 30-second observation is performed. If two (or more) of the three drops wicks into the carpet sample in less than 30 seconds, the carpet sample is considered to have failed for the Grade W solution. If two (or more) drops remain on the surface of the carpet sample in a generally spherical form, the carpet sample passes for the Grade W solution and the test is repeated with the Grade 1 solution. This process is repeated until the carpet sample eventually fails to maintain at least two drops of a particular solution on the surface of the carpet sample. The highest grade solution for which the carpet sample passes is recorded. If the carpet sample fails Grade W, an F is assigned. This indicates the carpet sample fails deionized water, consequently, failing all solution grades.

A float test is also used to determine the performance of a surface treatment polymer. The float test is performed by placing a carpet sample pile side down in a container of water such that the carpet sample floats on the surface of the water for a period of time. The amount of time that the carpet sample remains afloat is measured. When a significant portion of the carpet sample begins to sink, the test is concluded and the total float time is recorded.

In the examples that follow, carpet samples are prepared in a manner approximating the conditions of a commercial exhaust treatment process. Multiple baths of surface treatment are prepared and applied to the carpet samples. The surface treatment baths are made using one of two surface treatment solutions. Sample A refers to an embodiment of the disclosed aqueous surfactant-free emulsion polymer surface treatment before it is diluted to form a surface treatment bath. Sample A is made of a surface treatment polymer in an aqueous continuous phrase. In the exemplary embodiment referred to herein, Sample A contains 20% surface treatment polymer by weight and 80% water. Both a low concentration treatment bath and a standard concentration treatment bath are made using Sample A. The low concentration treatment bath is referred to as Sample Al and the standard concentration treatment bath is referred to as Sample A2.

Sample B refers to a conventional surfactant-stabilized polymer surface treatment before it is diluted to form a surface treatment bath. Samples B contains 30% of a surface treatment polymer and the remaining 70% is a combination of water and surfactants or emulsifiers. Both a low concentration treatment bath and a standard concentration treatment bath were made using Sample B. Additionally, the Sample B formulations were applied to carpet samples in two different methods. First, the Sample B formulations were applied to the carpet samples without the use of auxiliaries or a rinse step. Then the Sample B formulations were applied to the carpet samples with the use of auxiliaries and a rinse step. The low concentration treatment bath applied without auxiliaries or a rinse step is referred to as Sample B1. The standard concentration treatment bath applied without auxiliaries or a rinse step is referred to as Sample B2. The low concentration treatment bath applied with auxiliaries and a rinse step is referred to as Sample B3. The standard concentration treatment bath applied with auxiliaries and a rinse step is referred to as Sample B4.

Sample A1 is a low concentration treatment bath containing 0.1% on weight of fiber emulsion (surfactant-free) (“owf % emulsion”) of Sample A. Sample A2 is a standard concentration treatment bath containing 0.4 owf % emulsion (surfactant-free) of Sample A. Samples B1 and B3 are low concentration treatment baths containing 0.067 owf % emulsion (surfactant-stabilized) of Sample B. Samples B2 and B4 are standard concentration treatment baths containing 0.267 owf % emulsion (surfactant-stabilized) of Sample B.

For clarity, owf % emulsion represents the amount of polymer emulsion (Sample A surfactant-free emulsion or Sample B surfactant-stabilized emulsion) expressed as a percent of the weight of the carpet sample fiber to be treated. This number is decided upon before preparing the treatment bath.

The percent on weight of fiber polymer (“owf % polymer”) is the amount of surface treatment polymer deposited on the carpet once all liquid is driven off from the drying process. This number is closely related to the owf % emulsion. Owf % emulsion can be converted to, or determined from, the owf % polymer using the known amount of solid polymer in a given polymer treatment emulsion such as Sample A or Sample B.

Before preparing the treatment baths, a percent wet pickup (wpu %) was initially decided upon. The percent wet pick-up represents the amount of treatment bath liquid absorbed by a carpet sample. The percent wet pickup is determined before preparing a surface treatment bath and impacts the preparation of the treatment bath. In commercial applications, the target wpu % will vary depending on the processing capabilities, such as water usage limitations and drying equipment, of a given application.

For the exemplary embodiments described below, the preparation of a surface treatment bath is described as follows.
1) A 12¼″×8¼″ carpet sample is cut.
2) The carpet sample is weighed. In this particular example, the carpet sample weights 51.56 grams. The weight of the carpet sample in combination with the desired percent wet pick up informs the weight of all of the components of the treatment bath to be applied to the carpet sample.
3) Calculate the weight of the treatment bath in grams using the pre-determined percent wet pick up. In this example, the percent wet pickup was set at 400%. Accordingly, the treatment bath weights 206.24 grams (51.56×400%). The weight of the treatment bath in grams represents the total weight of the bath to be applied to the carpet sample. In some embodiments, the treatment bath includes only water and a surfactant-free emulsion surface treatment. In some embodiments, the treatment bath includes water, a surfactant-stabilized emulsion surface treatment, and auxiliaries such as salt solutions.
4) Calculate the percent on weight of bath (owb %). The percent on weight of bath represents the percent of the bath that will consist of a surface treatment emulsion. To calculate percent on weight of bath (owb %), divide the percent on weight of fiber emulsion by the percent wet pickup; then, multiply by 100 to convert the value to percent. One exemplary embodiment of the percent on weight of bath calculation is shown below.

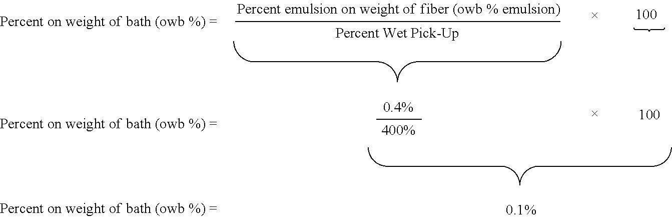

5) Calculate the amount (in grams) of surfactant-free emulsion surface treatment (or surfactant-stabilized emulsion) to add to the treatment bath. To determine the amount (in grams) of surfactant-free emulsion surface treatment (or surfactant-stabilized emulsion) to add to the treatment bath, multiply the weight of the treatment bath (in grams) by the percent on weight of bath (owb %) as shown in the exemplary calculation below.

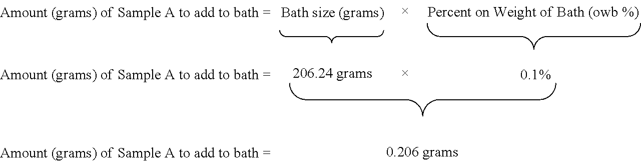

6) Determine the amount (in grams) of water needed in the treatment bath. The amount of water in the treatment bath refers to the additional amount of water, in addition to the other treatment bath components, needed to reach the target treatment bath weight. To determine how much additional water is needed, subtract the amount of surfactant-free emulsion surface treatment (or surfactant-stabilized emulsion) in the treatment bath from the total bath size. An exemplary calculation is shown below.

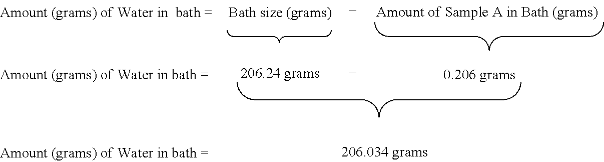

Once the desired amount of water has been calculated, combine the water, surfactant-free emulsion surface treatment (or surfactant-stabilized emulsion) and any auxiliaries. Mix the components of the treatment bath until they are thoroughly incorporated.

Once a treatment bath has been prepared, a carpet sample can be treated. In the examples described below, the carpet samples are treated according to the following exemplary process.
1) The carpet samples having a known dry weight are saturated with water.
2) The carpet samples are pre-steamed for 90 seconds. In a typical carpet mill setting, before the carpet is treated, it goes through a steam process to apply dye to the fiber. This dye process typically occurs before the carpet sample goes through the exhaust application for applying a surface treatment. In the exemplary embodiments described below, the carpet samples are not dyed. The pre-steam is used to emulate the dye process.
3) After the pre-steaming, the carpet sample is vacuum extracted to remove the excess moisture and achieve approximately 50%-70% moisture content. To achieve approximately 50% -70% moisture, the weight of the carpet sample plus remaining liquid is determined. The weight of the dry carpet sample was measured at the beginning of the bath preparation process. When the carpet sample has been vacuum extracted to about 50%-70% moisture, the weight of the carpet will be 50%-70% heavier than the dry carpet sample due to the remaining moisture content. An exemplary calculation is shown below.

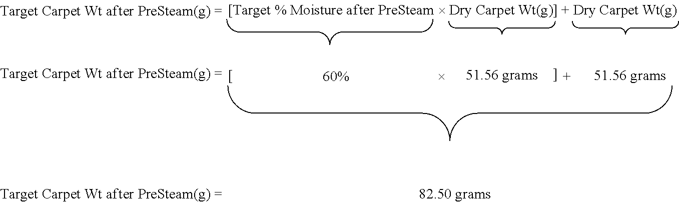

4) Once the carpet sample reaches approximately 50%-70% moisture, the surface treatment bath is applied to the carpet. In this exemplary embodiment, this is done by pouring the surface treatment bath into a clean tray and placing the carpet sample pile side down into the tray. In traditional carpet mills, the carpet is attached to a conveyor system. The carpet passes through a delivery system containing the treatment bath with the pile-side of the carpet facing the liquid. In the described examples, this is emulated using a tray containing the treatment bath as described above.
5) The treatment bath is then massaged into the carpet fibers. This massaging emulates the delivery system in the application process in the carpet mill setting. In the described examples, the carpet samples were massaged by hand to thoroughly incorporate the treatment bath into the fibers.
6) Once the treatment bath has been applied, the carpet sample is steamed for 90 seconds. This step reproduces the exhaust process in the carpet mill. In traditional surface treatment surfactant-stabilized emulsions, this steaming step may also be necessary to release the surface treatment polymer from the surfactant or emulsifier.

For treatment baths containing traditional surfactant-stabilized emulsion surface treatments, it is necessary to rinse the carpet sample to remove any residual surfactants or emulsifiers from the surface of the fibers. When using embodiments of the described surfactant-free emulsion surface treatment, the rinse step is eliminated because no surfactants or emulsifiers are used. Eliminating this rinse step saves carpet mills time, water, and energy.
7) After the treated carpet sample has been steamed and/or rinsed, the carpet sample is vacuum extracted to approximately 30%-50% moisture content. In a traditional mill setting, excess moisture is removed to allow for reduced oven drying times.
8) Finally, the carpet sample is dried. In the described exemplary embodiments, the carpet sample is placed pile-side up, on a conveyor oven. The carpet sample is dried at about 114° C. (238° F.) for 10 minutes. After the drying step is complete, the excess moisture is removed from the carpet sample leaving only the dried surface treatment polymer remaining on the carpet fibers.

### EXAMPLES

The surface treatment examples described below are performed on carpet samples consisting of three different materials, Polyethylene terephthalate (PET), Polytrimethylene terephthalate (PTT), and Polyamide (Nylon). Carpet face weight is defined as the ounce of fiber per square yard (osy). Face weight is the weight of the fiber portion of the carpet sample only. Carpet face weights can range from less than 20 osy up to 100 osy. Typical range is 20 osy-60 osy.

Examples 1-3 are focused on the repellency performance of carpet samples treated with Samples A1, A2, B1 and B2 described above. In Examples 1-3 each of these samples is tested on PET, PTT, and Nylon carpet samples without the use of any pH adjustment, salt addition, or a final rinse step following the steaming of the treated carpet sample. For Examples 1-3, treatment bath Sample A1 and A2 contained only surfactant-free emulsion surface treatment polymer and water. For Examples 1-3, treatment bath Sample B1 and B2 contained only surfactant-stabilized emulsion and water. No auxiliaries were used. After the surface treatment bath was applied to the carpet sample, the carpet sample was steamed for 90 seconds, vacuum extracted to reduce the moisture content and then dried. No rinse step was performed after the surface treatment polymer was applied to the carpet sample.

The PET, PTT, and Nylon carpets were cut into 8.25 inch×12.25 inch carpet samples and individually weighed. The total weight of each treatment bath was determined by multiplying the weight of the associated carpet sample by 400%, the pre-determined percent wet pickup. The low concentration treatment baths, Sample Al and Sample Bl, were each formulated to contain 0.02% on weight of fiber polymer. For clarity, this means amount of dry surface treatment polymer in each treatment bath was equal to 0.02% of the weight of the associated carpet sample. The standard concentration treatment baths, Samples A2 and B2, were each formulated to contain 0.08 owf % polymer.

The surface treatment baths were applied to the carpet following the process described above.

### Example 1—PET Carpet Samples

In Example 1, a 20 osy-25 osy cut pile PET carpet was treated following the method described above. The aqueous liquid repellency (Modified AATCC test method 193-2017) and float performance of the carpet samples treated with A1, A2, B1, and B2 were determined and compared. The aqueous liquid repellency test of the carpet samples treated with Samples A1 and A2 showed the ability to repel lower surface tension liquids better than the carpet samples treated with Samples B1 and B2. Float testing showed the carpet sample treated with Sample Al floated longer than the carpet sample treated with Sample B1 indicating that at lower than typical treatment levels, the surfactant-free emulsion of Sample A performs better than the surfactant-stabilized emulsion of Sample B. The float performance for the carpet samples treated with Samples A2 and B2 appeared to be generally equivalent. The test results are shown in Table 1 below.

TABLE 1
PET carpet samples treated without pH adjustment, salt, or rinse

| Treatment | Bath Dosage | owf % | Modified AATCC | | |
|---|---|---|---|---|---|
| Bath Sample | (grams/Liter) | polymer | 193-2017 | Float (time) | |
| A1 | 0.25 | 0.02% | 2 | >8 hrs, <24 hrs | |
| B1 | 0.17 | 0.02% | 1 | 1 | min |
| A2 | 1.00 | 0.08% | 3 | >24 | hrs |
| B2 | 0.67 | 0.08% | 2 | >24 | hrs |

For clarity, “Bath Dosage (grams/Liter)” refers to grams of the surfactant-free emulsion of Sample A or the surfactant-stabilized emulsion of Sample B per liter of water in the treatment bath.

### Example 2—PTT Carpet Samples

In Example 2, a 35 osy-40 osy cut pile PTT carpet was treated and dried by the method described above. The aqueous liquid repellency (Modified AATCC test method 193-2017) and float performance of carpet samples treated with A1, A2, B1, and B2 were determined and compared.

The aqueous liquid repellency of the carpet samples showed the ability of Sample A to repel lower surface tension liquids better than Sample B as indicated by the Modified AATCC test method 193-2017 grading. The float test showed the carpet samples treated with Samples A1 and A2 floated longer than the carpet samples treated with Samples B1 and B2 indicating that at both low and standard concentrations of surface treatment, Sample A performs better than Sample B. The test results are shown in Table 2 below.

TABLE 2
PTT carpet samples treated without pH adjustment, salt, or rinse

| Treatment | Bath Dosage | owf % | Modified AATCC | | |
|---|---|---|---|---|---|
| Bath Sample | (grams/Liter) | polymer | 193-2017 | Float (time) | |
| A1 | 0.25 | 0.02% | 2 | 47.4 | min |
| B1 | 0.17 | 0.02% | 1 | 2.9 | min |
| A2 | 1.00 | 0.08% | 3 | >24 | hrs |

| | | | | |
|---|---|---|---|---|
| B2 | 0.67 | 0.08% | 2 | >8 hrs, <24 hrs |

### Example 3—Nylon Carpet Samples

In Example 3, a 20 osy-25 osy cut pile nylon carpet was treated and dried by the method described above. The aqueous liquid repellency (Modified AATCC test method 193-2017) and float performance of the carpet samples treated with samples A1, A2, B1, and B2 were determined and compared. In this example, a “W” rating indicates at least two of the three drops of 100% deionized water remained on the surface of the carpet sample for at least 30 seconds and an “F” indicates a failing of the test using 100% deionized water. The aqueous liquid repellency test showed the ability of Sample A1 to repel deionized water on nylon better than Sample B1. In addition, the aqueous liquid repellency test showed the ability of Sample A2 to repel lower surface tension liquids better than Sample B2. The carpet samples treated with Samples A1 and B1 did not float for a measurable amount of time indicating that neither of the low concentration surface treatment baths could produce any float performance on nylon carpet samples. Only the Nylon carpet sample treated with Sample A2, floated for a measurable amount of time. The test results are shown in Table 3 below.

TABLE 3
Nylon carpet samples treated without pH adjustment, salt, or rinse

| Treatment | Bath Dosage | owf % | Modified AATCC | | |
|---|---|---|---|---|---|
| Bath Sample | (grams/Liter) | polymer | 193-2017 | Float (time) | |
| A1 | 0.25 | 0.02% | W | 0 | min |
| B1 | 0.17 | 0.02% | F | 0 | min |
| A2 | 1.00 | 0.08% | 3 | >8 hours, <24 | |
| | | | | hours | |
| B2 | 0.67 | 0.08% | W | 0 | min |

In Examples 4-6, repellency performance testing was conducted on PET, PTT, and Nylon carpet samples treated with Sample Bat a low dosage (Sample B3) and a high dosage (Sample B4). These examples represent the typical method for carpet exhaust treatments. In Examples 4-6, the pH of each treatment bath was adjusted to pH 2 with a sulfuric acid solution. A 30% magnesium sulfate solution was added to each treatment bath to create a 1.4% magnesium sulfate bath. After the carpet samples were treated with the polymer surface treatment and steamed, the carpet samples were rinsed thoroughly with water to remove any residual auxiliaries, surfactants, or emulsifiers. Other than these modifications, the preparation of the carpet samples and the application of the surface treatment polymer was the same as described above and used in Examples 1-3. Repellency performance was determined using the Modified AATCC test method 193-2017 and float test as described above.

### Example 4—PET Carpet Samples

In Example 4, a 20 osy-25 osy cut pile PET carpet was treated and dried by the method described above. The aqueous liquid repellency (Modified AATCC test method 193-2017) and float performance of the carpet samples treated with Samples B3 and B4 were determined and compared. The test results are shown in Table 4 below.

TABLE 4
PET carpet samples treated with pH adjustment,
magnesium salt, and rinse

| Treatment | Bath Dosage | owf % | Modified AATCC | | |
|---|---|---|---|---|---|
| Bath Sample | (grams/Liter) | polymer | 193-2017 | Float (time) | |
| B3 | 0.17 | 0.02% | 2 | 53.7 | min |
| B4 | 0.67 | 0.08% | 3 | >24 | hrs |

### Example 5—PTT Carpet Samples

In Example 5, a 35 osy-40 osy cut pile PTT carpet was treated and dried by the method described above. The aqueous liquid repellency and float performance of the carpet samples treated with Samples B3 and B4 were determined. The test results are shown in Table 5 below.

TABLE 5
PTT carpet samples treated with pH adjustment,
magnesium salt, and rinse

| Treatment | Bath Dosage | owf % | Modified AATCC | |
|---|---|---|---|---|
| Bath Sample | (grams/Liter) | polymer | 193-2017 | Float (time) |
| B3 | 0.17 | 0.02% | 1 | 1.3 min |
| B4 | 0.67 | 0.08% | 2 | 2.7 min |

### Example 6—Nylon Carpet Samples

In Example 6, a 20 osy-25 osy cut pile nylon carpet was treated and dried by the method described above. The aqueous liquid repellency and float performance of the carpet samples treated with Samples B3 and B4 were determined. The test results are shown in Table 6 below.

TABLE 6
Nylon carpet samples treated with pH
adjustment, magnesium salt, and rinse

| Treatment | Bath Dosage | owf % | Modified AATCC | |
|---|---|---|---|---|
| Bath Sample | (grams/Liter) | polymer | 193-2017 | Float (time) |
| B3 | 0.17 | 0.02% | W | 1.3 min |
| B4 | 0.67 | 0.08% | 3 | 184 min |

For Tables 7-9 below, carpet samples treated with Samples A1 and A2 without pH adjustment, salt solution, or rinse are compared to carpet samples treated with Samples B3 and B4 which did use pH adjustment, magnesium salt, and rinse.

TABLE 7
Surfactant-free emulsion compared to surfactant-
stabilized emulsion on PET carpet samples

| Treatment | Bath Dosage | owf % | Modified AATCC | | |
|---|---|---|---|---|---|
| Bath Sample | (grams/Liter) | polymer | 193-2017 | Float (time) | |
| A1 | 0.25 | 0.02% | 2 | >8 hrs, <24 hrs | |
| B3 | 0.17 | 0.02% | 2 | 54.7 | min |
| A2 | 1 | 0.08% | 3 | >24 | hrs |
| B4 | 0.67 | 0.08% | 3 | >24 | hrs |

TABLE 8
Surfactant-free emulsion compared to surfactant-
stabilized emulsion on PTT carpet samples

| Treatment | Bath Dosage | owf % | Modified AATCC | | |
|---|---|---|---|---|---|
| Bath Sample | (grams/Liter) | polymer | 193-2017 | Float (time) | |
| A1 | 0.25 | 0.02% | 2 | 47.4 | min |
| B3 | 0.17 | 0.02% | 1 | 1.3 | min |
| A2 | 1 | 0.08% | 3 | >24 | hrs |
| B4 | 0.67 | 0.08% | 2 | 2.7 | min |

TABLE 9
Surfactant-free emulsion compared to surfactant-
stabilized emulsion on Nylon carpet samples

| Treatment | Bath Dosage | owf % | Modified AATCC | | |
|---|---|---|---|---|---|
| Bath Sample | (grams/Liter) | polymer | 193-2017 | Float (time) | |
| A1 | 0.25 | 0.02% | W | 0 | min |
| B3 | 0.17 | 0.02% | W | 1.3 | min |
| A2 | 1 | 0.08% | 3 | >8 hrs, <24 hrs | |
| B4 | 0.67 | 0.08% | 3 | 184 | min |

As can be seen from the comparison of data in Tables 7-9, the polymer surface treatment surfactant-free emulsion of Sample A is an improvement to the traditional carpet exhaust process which utilizes surfactant-stabilized emulsion treatments similar to Sample B. In addition to the improved repellency performance, the surfactant-free emulsion of Sample A does not require pH adjustment, a salt solution, or a final rinsing step. These improvements provide carpet manufacturers the opportunity to save time, water, and energy in their process by reducing the amount of surface treatment needed to achieve passing results and reducing the amount of water used in the treatment process. Other cost saving, safety, and environmental advantages include the protection of equipment by eliminating corrosive auxiliary chemistries and reducing the amount of water used by eliminating the rinse step.

Those skilled in the art will recognize improvements and modification to the preferred embodiments of the present disclosure. All such improvements and modifications are considered within the scope of the concepts disclosed herein and the claims that follow. It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and are capable of changes or modifications within the scope of the teachings as expressed herein, commensurate with the skill and/or knowledge of a person having ordinary skill in the relevant art. The embodiments described herein above are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein. Any section headings herein are provided only for consistency with the suggestions of 37 C.F.R. § 1.77 or otherwise to provide organizational queues. These headings shall not limit or characterize the invention(s) set forth herein.

1. A method of treating carpet comprising:
applying a surfactant-free emulsion of a surface treatment polymer to a carpet wherein the surface treatment polymer is formed by solution polymerization, and
drying the carpet after the surfactant-free emulsion of a surface treatment polymer is applied to the carpet.

2. The method of treating carpet of claim 1, wherein the step of drying the carpet is performed by heating the carpet.

3. The method of treating carpet of claim 2, wherein the carpet is heated to a temperature of at least 60° C. or above 93° C. (200° F.) for a time of 1 second to 500 minutes.

4. The method of treating carpet of claim 1, wherein the step of drying the carpet is performed without rinsing the carpet after the surfactant-free emulsion is applied to the carpet.

5. The method of treating carpet of claim 1, wherein the surfactant-free emulsion is applied to the carpet without the use of a salt solution.

6. The method of treating carpet of claim 1, wherein the surfactant-free emulsion is applied to the carpet without the use of a magnesium salt solution.

7. The method of treating carpet of claim 1, wherein the carpet is dried before any solution with conductivity of greater than 0.1 mS/cm is applied to the carpet.

8. The method of treating carpet of claim 1, wherein the surfactant-free emulsion is applied to the carpet without the use of a separate acidic solution.

9. The method of treating carpet of claim 1, wherein the surfactant-free emulsion has a pH greater than 4.0 as it is applied to the carpet.

10. The method of treating carpet of claim 1, wherein the surfactant-free emulsion has a pH between 4.5 and 10.0 as it is applied to the carpet.

11. The method of treating carpet of claim 1, wherein the carpet is dried before any separate pH adjusting agent is applied to the carpet.

12. The method of treating carpet of claim 1, wherein the surfactant-free emulsion is substantially free of emulsifiers.

13. The method of treating carpet of claim 1, wherein the surface treatment polymer is fluorine free.

14. The method of treating carpet of claim 1, wherein the surface treatment polymer comprises (a) a repeating unit formed from an acrylic monomer having a hydrocarbon group containing 7 to 40 carbon atoms, (b) a repeating unit formed from an acrylic monomer having a hydrophilic group, and (c) a repeating unit formed from a monomer having an ion-donating group.

15. The method of treating carpet of claim 14, wherein the ion-donating group is a cation-donating group.

16. The method of treating carpet of claim 15, wherein the cation-donating group is an amino group.

17. A method of treating a textile comprising:
saturating the textile with a treatment bath, the treatment bath comprising a surfactant-free emulsion of a surface treatment polymer, wherein the surface treatment polymer comprises (a) a repeating unit formed from an acrylic monomer having a hydrocarbon group, (b) a repeating unit formed from an acrylic monomer having a hydrophilic group, and (c) a repeating unit formed from a monomer having a cation-donating group; and
heating the textile to reduce the moisture content without rinsing the textile after saturating the textile with the treatment bath.

18. The method of treating a textile of claim 17, wherein the treatment bath is substantially free of emulsifiers.

19. The method of treating a textile of claim 17, wherein the textile is a continuous or semi-continuous web of carpet.

20. The method of treating a textile of claim 17, wherein the textile is a carpet comprising polyethylene terephthalate (PET) or polytrimethylene terephthalate (PTT) fibers.
